(19) United States
(12) Patent Application Publication
(10) Pub. No.: US 2025/0119843 A1
(43) Pub. Date: Apr. 10, 2025

(54) EMISSION POWER ADJUSTING METHOD, COMMUNICATION CHIP, AND ELECTRONIC DEVICE

(71) Applicant: GUANGDONG OPPO MOBILE TELECOMMUNICATIONS CORP., LTD., Dongguan (CN)

(72) Inventor: Guangshu MA, Dongguan (CN)

(73) Assignee: GUANGDONG OPPO MOBILE TELECOMMUNICATIONS CORP., LTD., Dongguan (CN)

(21) Appl. No.: 18/982,560

(22) Filed: Dec. 16, 2024

Related U.S. Application Data
(63) Continuation of application No. PCT/CN2023/090946, filed on Apr. 26, 2023.

(30) Foreign Application Priority Data
Jul. 29, 2022 (CN) 202210911022.8

(51) Int. Cl. H04W 52/26

(52) U.S. Cl. CPC H04W 52/26

(57) ABSTRACT

An emission power adjusting method, a communication chip, and an electronic device are provided. The method includes: during a scanning cycle, adjusting the emission power according to a first adjusting time interval, a configured step size and an adjusting direction, performing a first type of frame data transfer, and obtaining data transmission performance data for the first type of frame data transfer; and in a case where it is determined that the data transmission performance data meets a condition for ceasing adjustment, ceasing further adjustment of the emission power, and determining an operating emission power. According to the sequential scanning mode, the operating transmission power of a wireless communication device is determined according to the changing trend of actual data transmission performance. Therefore, the optimal emission power of the wireless communication device may be determined while the wireless communication service requirement is met, thereby effectively reducing device power consumption.

### CROSS REFERENCE TO RELATED APPLICATIONS

This application is a continuation of International Patent Application No. PCT/CN 2023/090946, filed Apr. 26, 2023, which claims priority to Chinese Patent Application No. 202210911022.8 filed Jul. 29, 2022, both of which are herein incorporated by reference in their entireties.

### TECHNICAL FIELD

The present disclosure relates to, but is not limited to the field of wireless communication technologies, and in particular relates to an emission power adjusting method, a communication chip, and an electronic device.

### BACKGROUND

In the field of wireless communication, an emitting end needs to adjust its emission power, so as to reduce the power consumption under the premise of ensuring a stable and reliable wireless data communication. Adopting a more precise and efficient emission power determination scheme is a critical step for enhancing performances of wireless communication devices and reducing their power consumption.

### SUMMARY

According to a first aspect, an emission power adjusting method is provided. The method includes: during a scanning cycle, adjusting an emission power according to a first adjusting time interval and based on a configured step size and an adjusting direction, performing a first type of frame data transfer, and obtaining data transmission performance data for the first type of frame data transfer; in a case where it is determined that the data transmission performance data meets a condition for ceasing adjustment, ceasing further adjustment of the emission power, and determining an operating emission power.

According to a second aspect, a communication chip including a processor is provided. The processor is configured to execute an emission power adjusting method. The method includes: during a scanning cycle, adjusting an emission power according to a first adjusting time interval and based on a configured step size and an adjusting direction, performing a first type of frame data transfer, and obtaining data transmission performance data for the first type of frame data transfer; in a case where it is determined that the data transmission performance data meets a condition for ceasing adjustment, ceasing further adjustment of the emission power, and determining an operating emission power.

According to a third aspect, an electronic device is provided. The electronic device includes one or more processors and a storage apparatus. The storage apparatus is configured to store one or more programs. The one or more programs may enable, when being executed by the one or more processors, the one or more processors to implement an emission power adjusting method. The method includes: during a scanning cycle, adjusting an emission power according to a first adjusting time interval and based on a configured step size and an adjusting direction, performing a first type of frame data transfer, and obtaining data transmission performance data for the first type of frame data transfer; in a case where it is determined that the data transmission performance data meets a condition for ceasing adjustment, ceasing further adjustment of the emission power, and determining an operating emission power.

Other features and advantages of the present disclosure will be set forth in the following specification and would become apparent in part from the specification, or would be understood through the implementation of the present disclosure. Other advantages of the present disclosure may be realized and attained by the technical schemes described in the specification, the claims, and accompanying drawings.

Upon reading and understanding the accompanying drawings and detailed description, other aspects may be understood.

### BRIEF DESCRIPTION OF THE DRAWINGS

The accompanying drawings are provided for facilitating understanding of the embodiments of the present disclosure, and constitute a part of the specification. These accompanying drawings are used, in conjunction with the embodiments of the present disclosure, to explain the technical schemes of the present disclosure, without limiting the technical schemes of the present disclosure. The accompanying drawings in the following description are only some embodiments of the technical schemes of the present disclosure. For those of ordinary skills in the art, other drawings may be obtained based on the structures illustrated in these accompanying drawings without creative efforts.

FIG. 1 is a schematic diagram illustrating a correspondence between transmission rate MCS and RSSI according to an embodiment of the present disclosure.

FIG. 2 is a flowchart of an emission power adjusting method according to an embodiment of the present disclosure.

FIG. 3 is a flowchart of another emission power adjusting method according to an embodiment of the present disclosure.

FIG. 4 is a flowchart of yet another emission power adjusting method according to an embodiment of the present disclosure.

FIG. 5 is a schematic diagram illustrating a correspondence between emission power and the transmission rate MCS according to an embodiment of the present disclosure.

FIG. 6 is a schematic diagram illustrating a correspondence between the emission power and an expected maximum data transmission throughput according to an embodiment of the present disclosure.

FIG. 7 is a flowchart of another emission power adjusting method according to an embodiment of the present disclosure.

FIG. 8 is a flowchart of another emission power adjusting method according to an embodiment of the present disclosure.

FIG. 9 is a flowchart of another emission power adjusting method according to an embodiment of the present disclosure.

FIG. 10 is a flowchart of another emission power adjusting method according to an embodiment of the present disclosure.

FIG. 11 is a schematic structural diagram of an emission power adjusting apparatus according to an embodiment of the present disclosure.

FIG. 12 is a schematic structural diagram of another emission power adjusting apparatus according to an embodiment of the present disclosure.

The implementation, the functional features, and the advantages of the technical schemes of the present disclosure will be further described in conjunction with the embodiments and with reference to the accompanying drawings.

### DETAILED DESCRIPTION

Technical schemes in embodiments of the present disclosure would be described clearly and thoroughly in conjunction with accompanying drawing of the embodiments of the present disclosure. Obviously, the described embodiments are only a part of the embodiments of the present disclosure, but not all of them. All other embodiments occur to a person of ordinary skills in the art based on embodiments of the present disclosure without creative efforts should all be within the protection scope of the present disclosure.

In addition, the descriptions relate to “first” and “second” etc., in the present disclosure are only for the purpose of description, and should not be construed as indicating or implying relative importance or implicitly indicating the number of the technical features referred to. Therefore, the feature preceded by “first”, “second” or the like may explicitly or implicitly includes at least one of the feature. In the description of the present disclosure, the term “a plurality of” means at least two, such as two, three, etc., unless otherwise specifically defined.

In addition, the technical schemes of the various embodiments of the present disclosure may be combined with each other, but such combinations must be based on what can be implemented by a person of ordinary skills in the art. If a combination of technical schemes leads to contradictions or is unimplementable, it should be considered that, such a combination does not exist, and is not within the protection scope of claimed by the present disclosure.

Before the specific embodiments are described, the following table illustrates the explanations of the abbreviations for the related terms involved in the present disclosure.

| Abbreviation | English Explanation |
|---|---|
| WLAN | Wireless Local Area Networks |
| AP | Access Point |
| Wi-Fi | Wireless Fidelity |
| STA | Station |
| RSSI | Received Signal Strength Indicator |
| MCS | Modulation and Coding Scheme |
| BER | Bit Error Ratio |
| GO | Group Owner |
| ACK | Acknowledge character |
| TCP | Transmission Control Protocol |
| UDP | User Datagram Protocol |
| BT | Bluetooth |
| LTE | Long Term Evolution |
| NR | New Radio |

In wireless communication systems, by controlling emission power at an emitting end, power consumption of devices may be reduced to some extent. Taking a Wi-Fi hotspot device as an example, in some feasible schemes, signal qualities of connected devices are periodically obtained, a transmission rate negotiation is then performed based on the signal qualities, a data transmission rate between a hotspot and the connected devices are determined. An emission power negotiation is further performed, and the emission power between the devices is finally determined. In these feasible schemes, the power matching each Wi-Fi data transmission rate is classified, based on a pre-configured correspondence between the transmission rates and the emission power, into different power levels. In a case where performance requirements of the wireless data transmission are met, a lower emission power level may be adopted. In this way, a beneficial effect of reducing chip power consumption, extending service life, and reducing mutual interference is achieved.

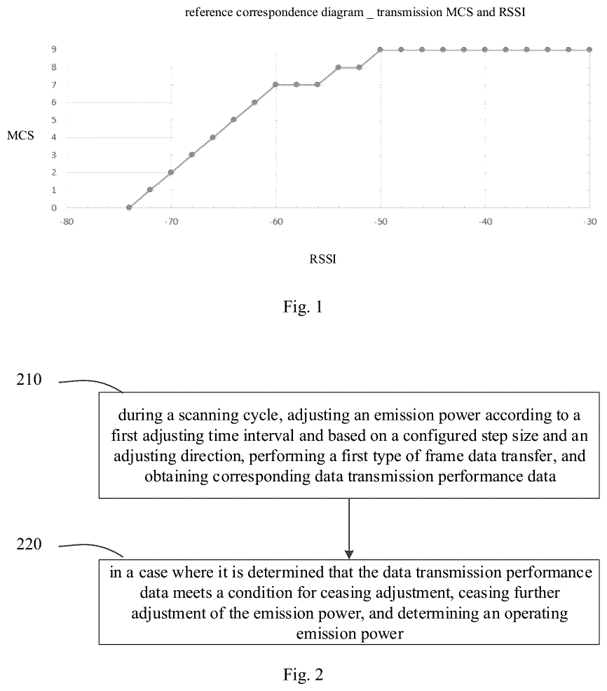

In some feasible schemes, the correspondence between the pre-configured transmission rate MCS and RSSI of devices is as illustrated in FIG. 1. According to both the correspondence between the pre-configured transmission rate MCS and RSSI as illustrated in FIG. 1 and the RSSI which characterizes the signal quality received by the connected devices, the matching transmission rate MCS is determined. The emission power is further determined accordingly.

Due to different signal reception capabilities of Wi-Fi chips, the correspondence between pre-configured rates and emission power levels for different chips varies. It is impractical to store the correspondence between the rates and the emission power for all chips in a single pre-configured correspondence table. Therefore, if the emission power is adjusted based on this technical scheme, a device development process would be more complicated, unfavorable situations such as poor compatibility with different Wi-Fi chips etc., would occur.

In addition, in the presence of the Wi-Fi interference or poor multi-path environments, the Wi-Fi transmission rate would decrease accordingly. Both the strength of the interference and the favorability of the multi-path environment require real-time change of the correspondence between the rate and the emission power in order to determine a more accurate emission power, thereby meeting the performance requirements of the wireless communication. Therefore, a dynamic adjustment of the emission power by adopting the configured/preconfigured transmission rates and emission power have very limited efficient application scenario.

It has been found through researches that, the Wi-Fi device has an auto-rate characteristic, also known as that, the Wi-Fi device has achieved an auto-rate algorithm. In other words, the transmission rate is automatically downgraded or upgraded based on the data transmission performance. In the presence of the Wi-Fi interferences or poor multi-path environments, since the data transmission performance is degraded, the Wi-Fi transmission rate would degrade accordingly. Therefore, the transmission rate may more directly reflect the current Wi-Fi communication performance, and may further serve as an adjusting basis for determining the emission power.

The embodiments of the present disclosure provide an emission power adjusting scheme. This emission power adjusting scheme determines a better emission power based on a changing trend of the transmission performance data of the wireless data. In this way, under the premise of ensuring the reliability of the wireless communication data transmission, a better emission power may be adopted, thereby achieving an aim of reducing the device power consumption.

An emission power adjusting method is provided in some embodiments of the present disclosure. The method includes operations at blocks illustrated in FIG. 2.

At block 210: during a scanning cycle, adjusting an emission power according to a first adjusting time interval and based on a configured step size and an adjusting direction, performing a first type of frame data transfer, and obtaining corresponding data transmission performance data.

At block 220: in a case where it is determined that the data transmission performance data meets a condition for ceasing adjustment, ceasing further adjustment of the emission power, and determining an operating emission power.

In some exemplary embodiments, the data transmission performance data includes: a data transmission rate or, an expected maximum data transmission throughput.

In some exemplary embodiments, a starting point for the adjustment of the emission power during each scanning cycle is a configured initial emission power.

In some exemplary embodiments, in a case where the adjusting direction is to decrease, the in a case where it is determined that the data transmission performance data meets the condition for ceasing adjustment, ceasing further adjustment of the emission power includes: in a case where the data transmission performance data drops below a first threshold, ceasing the further adjustment of the emission power.

In other words, in a case where the data transmission performance data drops below the first threshold, the condition for ceasing adjustment is met.

After further adjustment of the emission power of a first type of frame data is ceased, the current emission power is determined as the operating emission power, and the wireless data transmission is performed to complete related service functions. The frame type or data type transmitted by the wireless data transmission process based on the determined operating emission power is determined according to relevant wireless communication service specifications, and is not limited to specific aspects.

In some exemplary embodiments, in a case where the adjusting direction is to increase, the in a case where it is determined that the data transmission performance data meets the condition for ceasing adjustment, ceasing further adjustment of the emission power includes: in a case where the data transmission performance data rises above a second threshold, ceasing the further adjustment of the emission power.

In other words, in a case where the data transmission performance data rises above the second threshold, the condition for ceasing adjustment is met.

In some exemplary embodiments, in a case where the data transmission performance data is the data transmission rate, the first threshold is a first rate threshold; or, in a case where the data transmission performance data is the data transmission rate, the second threshold is a second rate threshold.

In some exemplary embodiments, in a case where the data transmission performance data is the expected maximum data transmission throughput, the first threshold is a first throughput threshold. Alternatively, in a case where the data transmission performance data is the expected maximum data transmission throughput, the second threshold is a second throughput threshold.

In some exemplary embodiments, if the adjusting direction is to decrease, the operations at blocks 210-220 may adopt successively decreased emission power to perform the first type of frame data transfer, so as to determine a final operating emission power. This process is also referred to as a power-down scanning process, which starts from the initial emission power and scans downward, so as to determine an optimal emission power that may meet the transmission requirements.

In some exemplary embodiments, if the adjusting direction is to increase, the operations at blocks 210-220 may adopt successively increased emission power to perform the first type of frame data transfer, so as to determine the final operating emission power. This process is also referred to as a power-up scanning process, which starts from the initial emission power and scans upward, so as to determine the optimal emission power that may meet the transmission requirements.

In some exemplary embodiments, the data transmission performance data includes the data transmission rate. Accordingly, in the power-down scanning scheme, in a case where it is determined that the data transmission rate being less than the first rate threshold, determining that the condition for ceasing adjustment is met; in the power-up scanning scheme, in a case where it is determined that the data transmission rate being greater than the second rate threshold, determining that the condition for ceasing adjustment is met.

In some exemplary embodiments, in the power-down scanning scheme, the initial emission power is a maximum power within a range permissible by a device or the environment. In some exemplary embodiments, in the power-up scanning scheme, the initial emission power is a minimum power within the range permissible by the device or the environment.

The following embodiments of the present disclosure provide more detailed descriptions through an example of the power-down scanning scheme. More aspects of the power-up scanning scheme may be determined likely, and examples would not be given case by case.

In some exemplary embodiments, the first adjusting time interval is of several milliseconds time duration. For example, the first adjusting time interval is 10 ms.

In some exemplary embodiments, the configured step sizes include equal step sizes or unequal step sizes, which are not limited to specific aspects. The step sizes are also referred to as increment values.

For example, an equal step size of 2 dBm means that, the emission power is adjusted to decrease by 2 dBm once at every first adjusting time interval, and the first type of frame data transfer is performed within this time interval. For an example where the initial emission power is 14 dBm and the first adjusting time interval is 10 ms, the first type of frame data is transferred at 14 dBm, 12 dBm, 10 dBm, 8 dBm, etc., respectively within every time interval of 10 ms. In some embodiments, the step size is 1 dBm. The smaller the step size, the more precisely the critical values may be determined, thereby reducing the power consumption. However, additional software and hardware overhead may also be introduced. Therefore, the step sizes may be determined comprehensively based on the overall system performance.

For example, in the case of unequal step sizes, the step sizes may be set to 1 dBm, 3 dBm, 5 dBm, etc. Taking the initial emission power of 14 dBm as an example, the emission power for transfer is decreased sequentially to 13 dBm, 10 dBm, 5 dBm, and so on.

Within the time duration of each first adjusting time interval, a transfer frequency or transfer approach of transferring the first type of frame data at the same emission power is implemented according to relevant schemes. This transfer frequency may be a consistent transfer frequency or be varying transfer frequencies, without being limited to any specific aspect.

In some exemplary embodiments, the first type of frame data is the data frame. The data frame is a data frame belonging to frame type 10 as defined in the 802.11 protocol. The data frame is a different type of frame compared to a control frame and a management frame. The management frame includes beacon frame). In some exemplary embodiments, with respect to a Wi-Fi system, the power-down scanning does not affect the power of beacon frames and/or control frames, as a reduction of power in beacon frames may prevent apparatuses from detecting the hotspot, and a reduction of power in control frame may directly impact the service interactions.

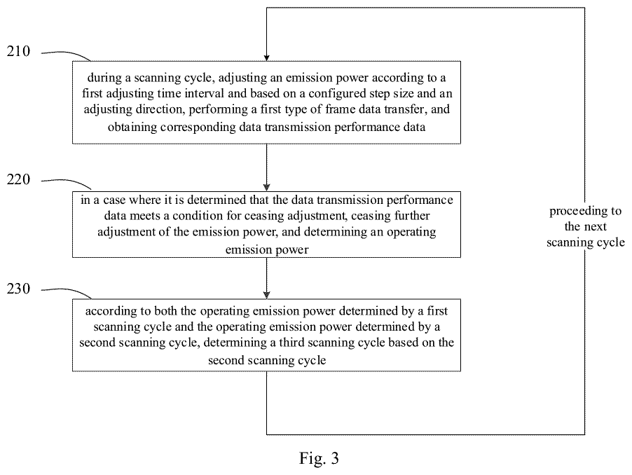

In some exemplary embodiments, the method further includes the operations illustrated at blocks of FIG. 3.

At block 230: according to both the operating emission power determined by a first scanning cycle and the operating emission power determined by a second scanning cycle, determining a third scanning cycle based on the second scanning cycle.

Here, the second scanning cycle is a scanning cycle following the first scanning cycle. The third scanning cycle is a scanning cycle following the second scanning cycle.

The first scanning cycle, the second scanning cycle and the third scanning cycle are three consecutive scanning cycles. In some embodiments, the first scanning cycle, the second scanning cycle and the third scanning cycle may accordingly be referred to as a previous scanning cycle, a present (current) scanning cycle or a next scanning cycle. In some embodiments, the first scanning cycle, the second scanning cycle and the third scanning cycle may accordingly be referred to as a preceding scanning cycle, the present (current) scanning cycle and a subsequent scanning cycle. The first scanning cycle, the second scanning cycle and the third scanning cycle are dynamically changing relative concepts.

In some exemplary embodiments, the operation at block 230 includes: in a case where the operating emission power in the second scanning cycle is the same as the operating emission power in the first scanning cycle, determining the third scanning cycle based on the second scanning cycle. Here, the third scanning cycle is greater than the second scanning cycle.

In some exemplary embodiments, the third scanning cycle is integer multiple of the second scanning cycle.

In some exemplary embodiments, according to pre-configured levels, the third scanning cycle is determined based on the second scanning cycle.

In some exemplary embodiments, selecting a scanning cycle matching a level lowered by one level according to the pre-configured levels. In the pre-configured levels, the lower the level, the longer the scanning cycle matching the level. In other words, according to the pre-configured levels, selecting, the scanning cycle matching a level reduced by one level from the level matching the second scanning cycle, as the third scanning cycle.

In some exemplary embodiments, selecting a scanning cycle matching a level increased by one level according to the pre-configured levels. In the pre-configured levels, the higher the level, the longer the scanning cycle matching the level. In other words, selecting, the scanning cycle matching a level increased by one level from the level matching the second scanning cycle, as the third scanning cycle.

In some exemplary embodiments, the operation at block 230 further includes: in a case where the operating emission power in the second scanning cycle is different from the operating emission power in the first scanning cycle, determining the third scanning cycle based on the second scanning cycle. Here, the third scanning cycle is equal to the second scanning cycle.

In some exemplary embodiments, the operation at block 230 further includes: in a case where the operating emission power in the second scanning cycle is different from the operating emission power in the first scanning cycle, determining the third scanning cycle based on the second scanning cycle. Here, the third scanning cycle is less than the second scanning cycle.

Accordingly, in some exemplary embodiments, by adopting an approach of pre-configured levels, the third scanning cycle having a shorter scanning cycle may be determined by either increasing or lowering the levels.

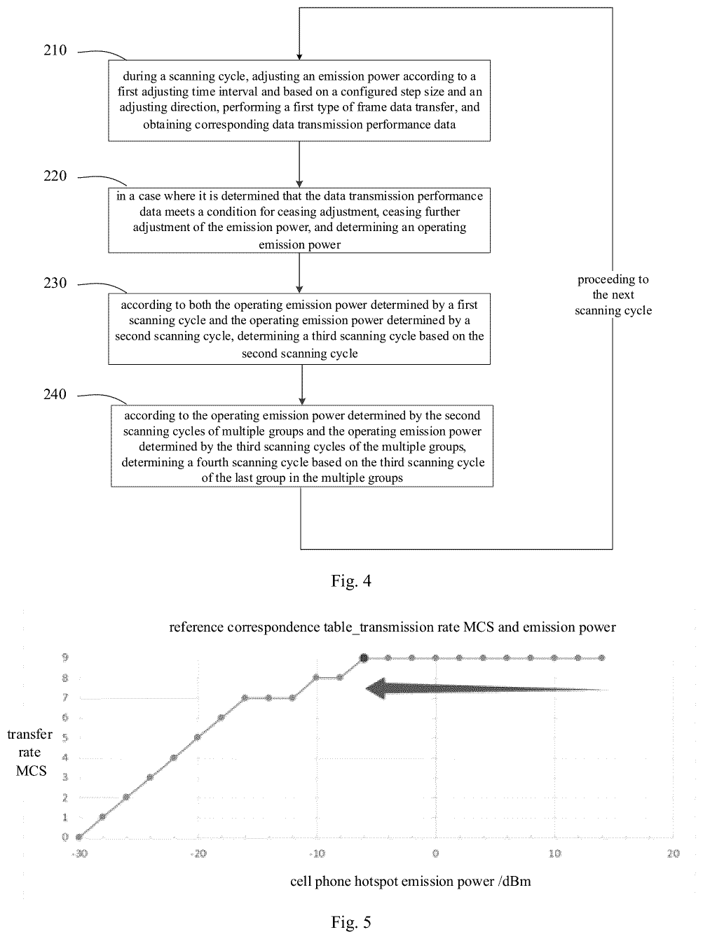

In some exemplary embodiments, as is illustrated in FIG. 4, FIG. 4 is a flowchart of yet another emission power adjusting method according to an embodiment of the present disclosure. The method further includes an operation at block 240: according to the operating emission power determined by the second scanning cycles of multiple groups and the operating emission power determined by the third scanning cycles of the multiple groups, determining a fourth scanning cycle based on the third scanning cycle of the last group in the multiple groups.

The fourth scanning cycle is a scanning cycle following the third scanning cycle in the last group. The fourth scanning cycle is less than the third scanning cycle in the last group.

One second scanning cycle and one third scanning cycle together constitute one group of second scanning cycle and third scanning cycle. In other words, the constituted one group includes both the second scanning cycle and the third scanning cycle. Here, the second scanning cycle and the third scanning cycle are dynamic relative concepts. For example, a scanning cycle a, a scanning cycle b, a scanning cycle c, a scanning cycle d, a scanning cycle e, a scanning cycle f, a scanning cycle g, . . . ; a first group (the scanning cycle b, the scanning cycle c), a second group (the scanning cycle c, the scanning cycle d), a third group (the scanning cycle d, the scanning cycle e), . . . The multiple groups may consist of: the first group and the second group. In some embodiments, the multiple groups may consist of: the first group, the second group, and the third group.

In some exemplary embodiments, the multiple groups are consecutive groups. For example, the scanning cycle a, the scanning cycle b, the scanning cycle c, the scanning cycle d, the scanning cycle e, the scanning cycle f, the scanning cycle g, . . . are consecutive multiple scanning cycles. The second group (the scanning cycle c, the scanning cycle d), the third group (the scanning cycle d, the scanning cycle e), a fourth group (the scanning cycle e, the scanning cycle f) are 3 consecutive groups. There are cases where more consecutive groups exist, which are not exhaustively listed here.

In some exemplary embodiments, the operation at block 240 includes: in a case where for the second scanning cycle and the third scanning cycle of each group, the operating emission power determined by the second scanning cycle is different from the operating emission power determined by the third scanning cycle, determining the fourth scanning cycle based on the third scanning cycle in the last group.

For example, if the multiple groups consist of two consecutive groups: the second group (the scanning cycle c, the scanning cycle d) and the third group (the scanning cycle d, the scanning cycle e), and the operating emission power determined by the scanning cycle c of the second group is different from the operating emission power determined by the scanning cycle d of the second group, the operating emission power determined by the scanning cycle d of the third group is also different from the operating emission power determined by the scanning cycle e of the third group, the fourth scanning cycle is thus determined based on the third scanning cycle (the scanning cycle e) of the last group of these two groups. The determined fourth scanning cycle is shorter than the third scanning cycle (the scanning cycle e) of the last group.

Accordingly, in some exemplary embodiments, by adopting the approach of pre-configured levels, the fourth scanning cycle having a shorter scanning cycle may be determined by either increasing or lowering the levels.

After the operation at block 230, according to the determined third scanning cycle, the process may enter the third scanning cycle and execute the operations at blocks 210 and 220 again; or may execute the operations at blocks 210, 220 and 230 again; or may execute the operations at blocks 210, 220, 230 and 240 again. After the operation at block 240, according to the determined fourth scanning cycle, the process may enter the fourth scanning cycle and execute the operations at blocks 210 and 220 again; or, may execute the operations at blocks 210, 220 and 230 again; or, may execute the operations at blocks 210, 220, 230 and 240 again.

In some exemplary embodiments, the method may be applied to or performed by a wireless communication device.

In some exemplary embodiments, the wireless communication device is a Wi-Fi device.

In some exemplary embodiments, the wireless communication device is a Wi-Fi hotspot device, a Wi-Fi AP device, or a Wi-Fi GO device.

In some exemplary embodiments, the wireless communication device has an auto-rate characteristic. In other words, the wireless communication device has a transmission rate adaptive adjustment function.

In some exemplary embodiments, in a case where the distance between the Wi-Fi hotspot and the STA is short, the Wi-Fi device usually selects a greater transmission rate, e.g., MCS9, based on its auto-rate characteristic.

In some exemplary embodiments, the correspondence between the cell phone hotspot emission power and the transmission rate is as illustrated in FIG. 5. As the emission power decreases, the data transmission rate that is adaptively determined by the cell phone hotspot varies accordingly. As illustrated in FIG. 5, when the emission power is reduced to a certain level, the data transmission rate begins to decrease. The first rate threshold is set according to the minimum data transmission rate that is acceptable to the system. For example, if the minimum data transmission rate acceptable to the system is MCS9, the first rate threshold is determined to MCS9. After the emission power is decreased, if the current data transmission rate is determined to be less than MCS9, which indicates that the data transmission rate has begun to decrease, the power-down scanning process is ceased. The finally adopted emission power is a critical value at which the data transmission rate begins to decrease. This critical value is determined as the operating emission power of the wireless communication device.

Taking FIG. 5 as an example, when the emission power decreases to −6 dBm, it is determined that the transmission rate is less than MCS9, indicating that the transmission rate has begun to decrease. Therefore, −6 dBm is determined as the critical value of the emission power, and is determined as the operating emission power. This emission power of −6 dBm is then adopted for subsequent transmission of service data.

In some exemplary embodiments, the data transmission performance data includes: the expected maximum data transmission throughput. Accordingly, the first threshold is the first throughput threshold.

In some exemplary embodiments, the adjustment of power is defined by adopting the relationship or correspondence between the emission power and the expected maximum data transmission performance Throughput.

In some exemplary embodiments, the expected maximum data transmission performance Throughput is calculated as follows: Throughput=Rate*(1−BER)*U*M. Here, Rate refers to a transfer rate of the first type of frame data, the unit of Rate is Mbps. In some exemplary embodiments, Rate is obtained from a data transfer device. BER refers to the bit error rate. In some exemplary embodiments, the bit error rate BER is obtained based on an ACK response from a data receiving device. U refers to an air interface utilization, indicating a percentage of time in which a channel is occupied for transfer of the first type of frame data. For example, under an ideal condition with full-service load, U would be 100%. M refers to an MAC utilization ratio, indicating a message overhead of an MAC frame header in communication messages. For example, M indicates the MAC frame header overhead in TCP/UDP messages. For example, M is 80%.

In other words, in some exemplary embodiments, the expected maximum data transmission performance Throughput is: Throughput=Rate*(1−BER)*100%*80%.

In some exemplary embodiments, in the case where the distance between the Wi-Fi hotspot and the STA is short, the Wi-Fi device usually selects a greater transmission rate based on its auto-rate characteristic, the expected maximum data transmission performance Throughput is 700 Mbps.

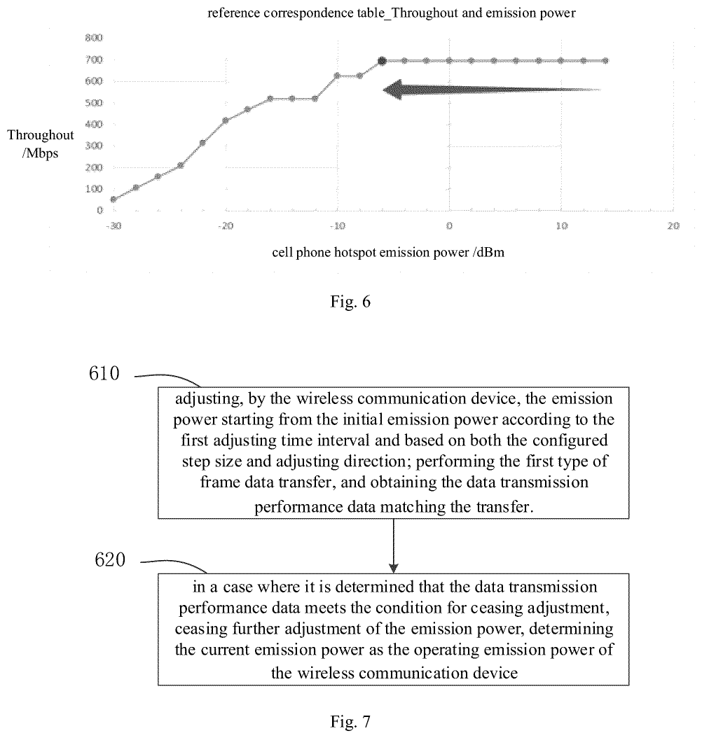

In some exemplary embodiments, the correspondence between the cell phone hotspot emission power and the Throughput is as illustrated in FIG. 6. As the emission power decreases, the data transmission rate that is adaptively determined by the cell phone hotspot varies accordingly. Accordingly, the expected maximum data transmission performance Throughput also varies. As illustrated in FIG. 6, when the emission power is decreased to a certain level, the Throughput begins to decrease. The first throughput threshold is set according to the minimum Throughput that is acceptable to the system. For example, if the minimum Throughput acceptable to the system is 700 Mbps, the first throughput threshold is determined to 700 Mbps. After the emission power is decreased, if the current Throughput is determined to be less than 700 Mbps, which indicates that the expected maximum data transmission throughput has begun to decrease, the power-down scanning process is ceased. The finally adopted emission power is the critical value at which the expected maximum data transmission throughput begins to decrease. This critical value is determined as the operating emission power of the wireless communication device.

Taking FIG. 6 as an example, when the emission power decreases to −6 dBm, it is determined that the Throughput is less than 700 Mbps, indicating that the expected maximum data transmission throughput has begun to decrease. Therefore, −6 dBm is determined as the critical value of the emission power, and is determined as the operating emission power. This emission power of −6 dBm is then adopted for subsequent transmission of the service data.

The wireless communication device is connected to one or more data receiving ends. Accordingly, the wireless communication device performs the emission power adjusting method, to determine the operating emission power for each data receiving end, for continuing the subsequent service data transmission.

In some exemplary embodiments, the data receiving end is the STA.

The embodiments of the present disclosure further provide an emission power adjusting method. The emission power adjusting method includes operations at blocks as illustrated in FIG. 7.

At block 610: adjusting, by the wireless communication device, the emission power starting from the initial emission power according to the first adjusting time interval and based on both the configured step size and adjusting direction; performing the first type of frame data transfer, and obtaining the data transmission performance data matching the transfer.

At block 620: in a case where it is determined that the data transmission performance data meets the condition for ceasing adjustment, ceasing further adjustment of the emission power, determining the current emission power as the operating emission power of the wireless communication device.

In some exemplary embodiments, if the adjusting direction is to decrease, the operations at blocks 610-620 may adopt successively decreased emission power to perform the first type of frame data transfer, so as to determine the final operating emission power. This process is also referred to as the power-down scanning process, which starts from the initial emission power and scans downward, so as to determine a better emission power that may meet the transmission requirements.

In some exemplary embodiments, if the adjusting direction is to increase, the operations at blocks 610-620 may adopt successively increased emission power to perform the first type of frame data transfer, so as to determine the final operating emission power. This process is also referred to as the power-up scanning process, which starts from the initial emission power and scans upward, so as to determine a better emission power that may meet the transmission requirements.

In some exemplary embodiments, the data transmission performance data includes the data transmission rate. Accordingly, in the power-down scanning scheme, in a case where it is determined that the data transmission rate is less than the first rate threshold, determining that the condition for ceasing adjustment is met; in the power-up scanning scheme, in a case where it is determined that the data transmission rate is greater than the second rate threshold, determining that the condition for ceasing adjustment is met.

In some exemplary embodiments, in the power-down scanning scheme, the initial emission power is the maximum power within the range permissible by the device or the environment. In some exemplary embodiments, in the power-up scanning scheme, the initial emission power is the minimum power within the range permissible by the device or the environment.

The following embodiments of the present disclosure provide more detailed descriptions through the example of the power-down scanning scheme. More aspects of the power-up scanning schemes may be determined similarly, and examples would not be given case by case.

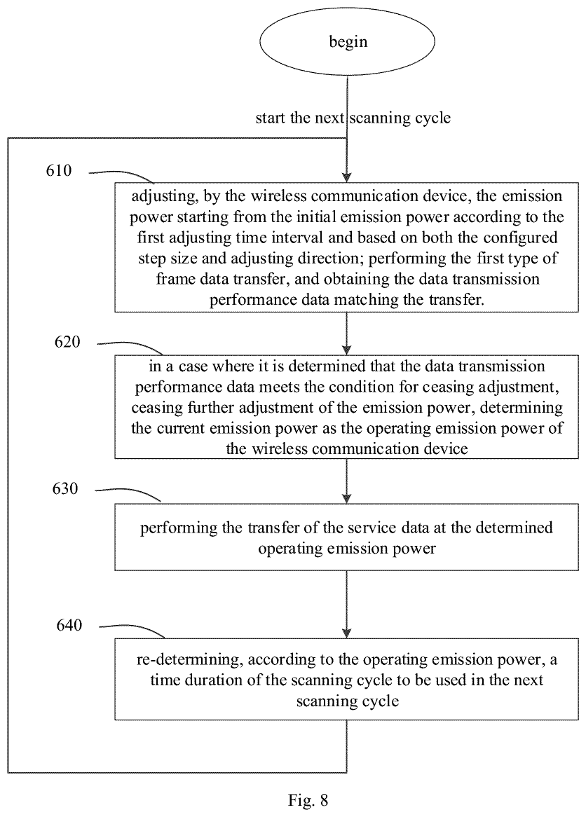

In some exemplary embodiments, the emission power adjusting method may further include operations illustrated at blocks of FIG. 8.

At block 630, during each scanning cycle, after determining, by the wireless communication device, the operating emission power, performing the transfer of the service data at the determined operating emission power.

At block 640: re-determining, according to the operating emission power, a time duration of the scanning cycle to be used in the next scanning cycle.

An initial value of the time duration of the scanning cycle is a configured initial time duration.

The operating emission power is determined by executing the operations at blocks 610-620.

Each scanning cycle matches a cycle, during which the emission power is determined and the service data is transferred. During a beginning stage of each scanning cycle, the power-down scanning is performed according to the initial emission power. A better emission power in the present cycle is determined under the premise of ensuring the data transmission reliability. During the remaining time of the present scanning cycle, the determined emission power is maintained for the service data transmission. In other words, the wireless communication device takes this determined emission power as an operating state parameter, and performs the service data transmission. Therefore, the determined emission power is also referred to as the operating emission power.

The length of the scanning cycle significantly impacts benefits of the actual power consumption control and a system software and hardware logic overhead. Too frequent scanning (i.e., the scanning cycle is relatively short) may lead to more software and hardware logic overhead. In addition, the critical point emission power or the expected maximum data transmission throughput usually remains stable, and would only change in dynamic scenarios, such as variations of interference conditions or variations of relative distances. However, such dynamic scenarios typically do not remain “dynamic” all the time. Therefore, embodiments of the present disclosure further provide the emission power adjusting method. In the emission power adjusting method, the scanning cycle is reasonably configured according to the determined result of the operating emission power during each scanning cycle, so as to control a balance between the scanning cost and the power consumption control.

In some exemplary embodiments, the operation at block 640 includes: in a case where the operating emission power P determined during the current scanning cycle is the same as the operating emission power P0 determined in the previous scanning cycle, the time duration of the scanning cycle is re-determined according to a cycle penalty mechanism. Here, the time duration of the re-determined scanning cycle is greater than the time duration of the current scanning cycle. In a case where the operating emission power determined during the current scanning cycle is different from the operating emission power determined in the previous scanning cycle, the time duration of the re-determined scanning cycle remains unchanged.

The cycle penalty mechanism refers to a pre-configured rule indicating how to determine the time duration of subsequent scanning cycles. This rule may, but is not limited to, specify how to re-determine the time duration of the scanning cycle according to the time duration of the current scanning cycle.

In some exemplary embodiments, the re-determining the time duration of the scanning cycle according to the cycle penalty mechanism includes: the re-determined time duration of the scanning cycle=n*the time duration of the current scanning cycle. n is a number greater than 1.

For example, n=2 indicates that the re-determined time duration of the scanning cycle is twice as much as the time duration of the current scanning cycle.

In some exemplary embodiments, the re-determining the time duration of the scanning cycle according to the cycle penalty mechanism includes: according to the pre-configured time duration levels, selecting the time duration of the scanning cycle matching a level lowered by one level as the re-determined time duration of the scanning cycle. Here, in the pre-configured time duration levels, the lower a level, the longer the time duration matching the level.

For example, the configured time duration levels range from low to high as follows: Level 1, Level 2, Level 3, and Level 4. The Level 1 matches the scanning cycle of 60 s, the Level 2 matches the scanning cycle of 20 s, the Level 3 matches the scanning cycle of 5 s, and the Level 4 matches the scanning cycle of 1 s, respectively. In some exemplary embodiments, if the current scanning cycle is of the Level 4 and matches with the time duration of 1 s, in a case where the operating emission power P, which is determined in the current scanning cycle by executing the operations at blocks 610-620, differs from the operating emission power P0, which is determined in the previous scanning cycle, the time duration matching with the current level remains unchanged. In other words, the time duration of the following scanning cycle would still be 1 s. In a case where the operating emission power P, which is determined in the current scanning cycle by executing the operations at blocks 610-620, is the same as the operating emission power P0, which is determined in the previous scanning cycle, the following scanning cycle is decreased to Level 3, the time duration of the scanning cycle matching the Level 3 is 5 s, and so on.

In some exemplary embodiments, the re-determining, according to the operating emission power, the time duration of the scanning cycle to be used in the following scanning cycle further includes: in a case where the operating emission power determined in any one scanning cycle of m consecutive scanning cycles differs from the operating emission power determined in the previous scanning cycle of the one scanning cycle, the re-determined time duration of the scanning cycle is less than the time duration of the current scanning cycle.

Here, m is an integer greater than 1.

In some exemplary embodiments, in a case where the determined operating emission power P in any one scanning cycle of the m consecutive scanning cycles differs from the operating emission power P0 determined in the previous scanning cycle of the one scanning cycle, selecting a time duration of a level increased by one level as the re-determined time duration of the scanning cycle.

For example, m=2, in a case where P0≠P in 2 consecutive scanning cycles, the process enters a level-increasing logic, the time duration of the scanning cycle is to be decreased. For example, from cycle 1 to cycle 3, the operating emission power determined accordingly are P1-P3 respectively. In a case where P3≠P2 and P2≠P1, the level is increased, and a shorter scanning cycle is adopted.

In some exemplary embodiments, in a case where the operating emission power P determined during the current scanning cycle is the same as the operating emission power P0 determined in the previous scanning cycle, the re-determined time duration of the scanning cycle according to the cycle penalty mechanism is greater than the time duration of the current scanning cycle. In a case where the operating emission power determined in one of two consecutive scanning cycles is the same as the operating emission power determined in another of the two consecutive scanning cycles, it is indicated that, the wireless environment in which the current wireless communication device is located is relatively stable, and the wireless communication environment varies very little. Therefore, by appropriately increasing the scanning cycle, the overhead proportion of the power-down scanning for determining the operating emission power during each scanning cycle may be reduced, and the overhead proportion for dynamically adjusting the emission power in the overall system operation may also be reduced.

In some exemplary embodiments, in a case where the operating emission power P determined during the current scanning cycle differs from the operating emission power P0 determined in the previous scanning cycle, the re-determined time duration of the scanning cycle remains unchanged. In a case where the operating emission power determined in one of two consecutive scanning cycles differs from the operating emission power determined in another of the two consecutive scanning cycles, it is indicated that the wireless environment in which the current wireless communication device is located has undergone some changes. Therefore, it is not suitable to increase the scanning cycle. Instead, the current time duration of the scanning cycle should be continuously maintained, so as to determine the available emission power more accurately and in real time. In this way, the power consumption is decreased under the premise of ensuring the data communication performance.

In some exemplary embodiments, if the determined operating emission power in any one scanning cycle of the m consecutive scanning cycles differs from the determined operating emission power of the respective previous scanning cycle of the one scanning cycle, it is indicated that, the wireless communication device is currently in a highly dynamic environment with relatively poor environmental stability. Therefore, the scanning cycle should be shortened accordingly, and the frequency of determining the operating emission power through scanning should be increased, thereby avoid the following scenario: during an excessively long scanning cycle, due to significant changes in the wireless communication environment, the operating emission power determined by the power-down scanning process during the earlier stage of the scanning cycle is maintained for data transmission throughout the remaining time of the scanning cycle, and is unable to meet the performance requirements of data transmission. Shortening the scanning cycle implies adopting a smaller execution interval to re-initiate the operation at block 610, thus an available optimized emission power is determined through re-scanning starting from the initial emission power.

In some exemplary embodiments, the time duration of the scanning cycle is less than the configured maximum time duration threshold. Accordingly, in the operation at block 640, the time duration of the following scanning cycle is re-determined within a range permitted by the maximum time duration threshold.

In some exemplary embodiments, the operation at block 640 includes: in a case where the operating emission power P determined by the current scanning cycle is the same as the operating emission power P0 determined by the previous scanning cycle, re-determining the time duration of the scanning cycle within the maximum time duration threshold range according to the cycle penalty mechanism. Here, the re-determined time duration of the scanning cycle is greater than or equal to the time duration of the current scanning cycle.

In some exemplary embodiments, the re-determining the time duration of the scanning cycle within the maximum time duration threshold range according to the cycle penalty mechanism includes: the re-determined time duration of the scanning cycle=Min (n*the time duration of the current scanning cycle, T). Here, Min () represents a minimum function or a smallest value function. n is a number greater than 1. T is the maximum time duration threshold.

For example, if the maximum time duration threshold is 8 s and the time duration of the current scanning cycle is 3 s, n is 2, the re-determined time duration of the scanning cycle would be 6 s. If the maximum time duration threshold is 8 s and the time duration of the current scanning cycle is 5 s, n is 2, the re-determined time duration of the scanning cycle would be 8 s.

In some exemplary embodiments, the re-determining the time duration of the scanning cycle within the maximum time duration threshold range according to the cycle penalty mechanism includes: the re-determined time duration of the scanning cycle=Min (X, T). Here, Min () represents the minimum function or the smallest value function. Tis the maximum time duration threshold. X is the time duration matching the level selected by lowering one level according to the pre-configured time duration levels.

The emission power adjustment scheme as described in embodiments of the present disclosure is not limited to being applied to the Wi-Fi wireless communication system, and may also be applied to other wireless communication systems such as BT, LTE, NR etc. During the initial stage of each scanning cycle, the power-down scanning approach or the power-up scanning approach is adopted. The data transmission rate or the expected maximum data transmission throughput, capable of more effectively evaluating the current communication performance of the wireless communication system, is used as a basis for the emission power adjustment. In this way, the real-time performance and the accuracy of dynamic adjustment of the emission power are enhanced.

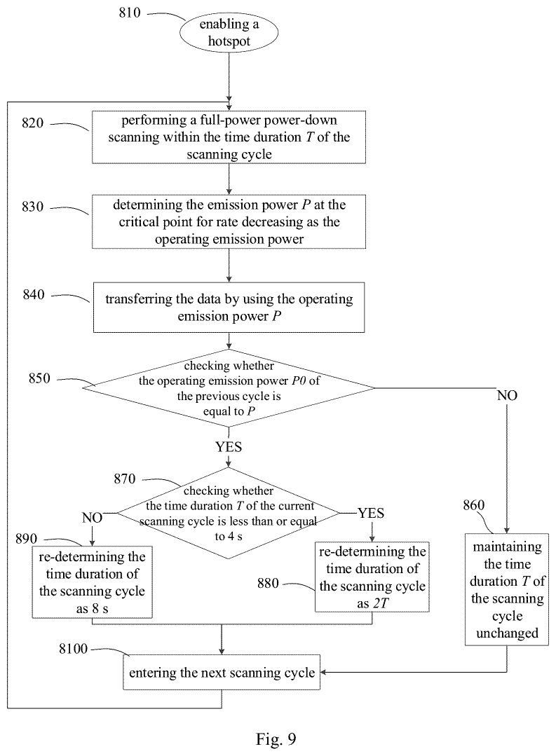

The present disclosure further provides the emission power adjusting method applied to the Wi-Fi hotspot device. n=2, m=2, and the maximum time duration threshold is 8 s. The method includes operations at blocks illustrated in FIG. 9.

At block 810: enabling a hotspot.

At block 820: performing a full-power power-down scanning within the time duration T of the scanning cycle.

At block 830: determining the emission power P at the critical point for rate decreasing as the operating emission power.

At block 840: transferring the data by using the operating emission power.

At block 850: checking whether the operating emission power P0 of the previous cycle is equal to P. If NO, proceeding to the operation at block 860. If YES, proceeding to the operation at block 870.

At block 860: maintaining the time duration T of the scanning cycle unchanged.

At block 870: checking whether the time duration T of the current scanning cycle is less than or equal to 4 s. If YES, proceeding to the operation at block 880. If NO, proceeding to the operation at block 890.

At block 880: re-determining the time duration of the scanning cycle as 2T.

At block 890: re-determining the time duration of the scanning cycle as 8 s.

At block 8100: entering the next scanning cycle.

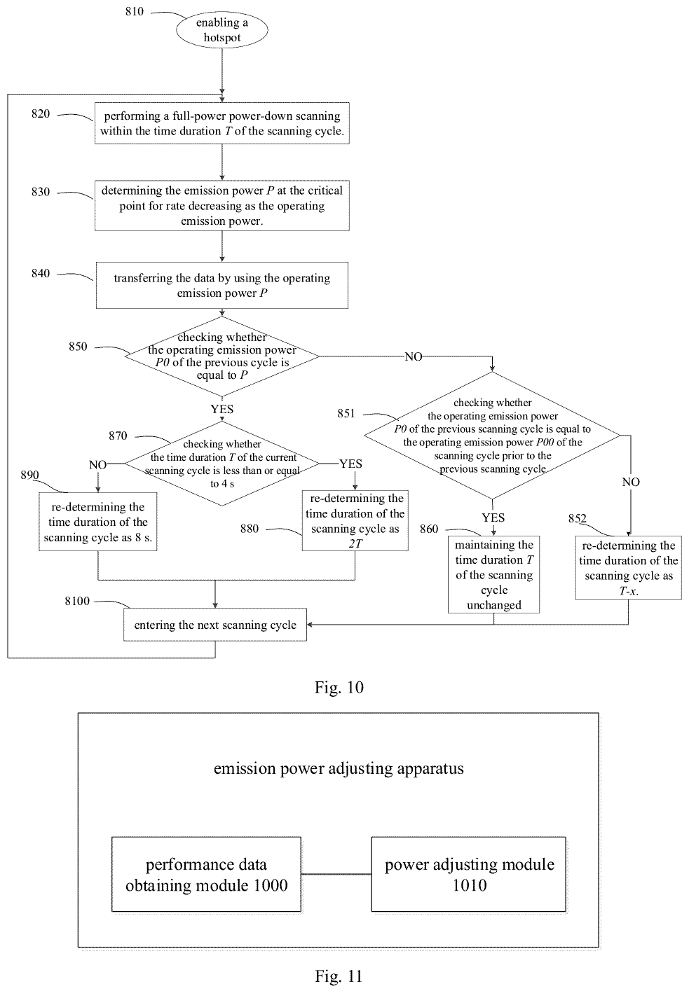

In some exemplary embodiments, as illustrated in FIG. 10, at block 850: checking whether the operating emission power P0 of the previous scanning cycle is equal to P. If NO, proceeding to the operation at block 851. If YES, proceeding to the operation at block 870.

At block 851: checking whether the operating emission power P0 of the previous scanning cycle is equal to the operating emission power P00 of the scanning cycle prior to the previous scanning cycle. If NO, proceeding to the operation at block 852. If YES, proceeding to the operation at block 860.

At block 852: re-determining the time duration of the scanning cycle as T−x.

Here, x is a positive integer. The scanning cycle prior to the previous scanning cycle is the previous scanning cycle of the previous scanning cycle.

The scanning time duration of the next scanning cycle is the time duration determined by operations at blocks 852, 860, 880 or 890.

Through the emission power adjustment scheme provided in some embodiments of the present disclosure, in one aspect, the power of the Wi-Fi chip at high transmission rates is accurately reduced, thereby saving energy and reducing likelihood of unauthorized network access. In another aspect, a higher power at a low transmission rate may be accurately selected, so as to ensure the actual performance of the wireless communication chip.

The present disclosure further provides an emission power adjusting apparatus. As illustrated in FIG. 11, the emission power adjusting apparatus includes a performance data obtaining module 1000 and a power adjusting module 1010.

The performance data obtaining module 1000 is configured to: during the scanning cycle, adjust the emission power according to the first adjusting time interval and based on the configured step size and the adjusting direction, perform the first type of frame data transfer, and obtain data transmission performance data for the first type of frame data transfer.

The power adjusting module 1010 is configured to: in a case where it is determined that the data transmission performance data meets a condition for ceasing adjustment, ceasing further adjustment of the emission power, and determining an operating emission power.

In some exemplary embodiments, the device is deployed on the Wi-Fi hotspot device, or on the Wi-Fi AP device, or on the Wi-Fi GO device.

In some exemplary embodiments, the apparatus is deployed on a Bluetooth device, on an LTE device, or on an NR device.

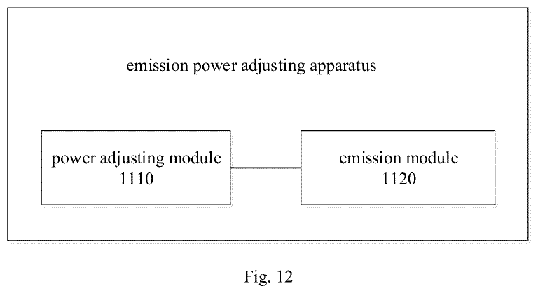

The present disclosure further provides an emission power adjusting apparatus. As illustrated in FIG. 12, the emission power adjusting apparatus includes: a power adjusting module 1110 and an emission module 1120.

The power adjusting module 1110 is configured to: during each scanning cycle, execute the method as described in any embodiment of the present disclosure, so as to determine the operating emission power.

The emission module 1120 is configured to perform the transfer of the service data at the determined operating emission power.

The power adjusting module 1110 is further configured to re-determine, according to the operating emission power, the time duration of the scanning cycle to be used in the following scanning cycle.

The initial value of the time duration of the scanning cycle is a configured initial time duration.

In some exemplary embodiments, the apparatus is deployed on the Wi-Fi hotspot device, or on the Wi-Fi AP device, or on the Wi-Fi GO device.

In some exemplary embodiments, the apparatus is deployed on the Bluetooth device, on the LTE device, or on the NR device.

The present disclosure further provides a communication chip. The communication chip includes a processor. The processor is configured to execute the emission power adjusting method as described in any embodiment of the present disclosure, so as to perform the emission power adjustment.

The present disclosure further provides an electronic device. The electronic device includes one or more processors and a storage apparatus. The storage apparatus is configured to store one or more programs.

The one or more programs, when being executed by the one or more processors, may enable the one or more processors to implement the emission power adjusting method as described in any embodiment of the present disclosure.

In some exemplary embodiments, the electronic device is the Wi-Fi hotspot device, the Wi-Fi AP device, or the Wi-Fi GO device.

In some exemplary embodiments, the electronic device is the Bluetooth device, the LTE device, or the NR device.

The present disclosure further provides a computer-readable storage medium storing a computer program. The computer program, when being executed by a processor, is configured to implement the emission power adjusting method as described in any embodiment of the present disclosure.

Through the emission power adjustment scheme provided in some embodiments of the present disclosure, the correspondence between the emission power and the data transmission performance of the current wireless communication device may be obtained in real time through a power scanning approach. In this way, the wireless communication emitting end may be enabled to more accurately select the optimal emission power under the premise of fully ensuring the fulfillment of the wireless communication service requirements. In some exemplary embodiments, by further dynamically adjusting the scanning cycles, the software and hardware overhead is reduced as much as possible, thereby increasing the overall device performance.

Those of ordinary skills in the art may understand that, all or some steps, systems, or function modules/units in the method disclosed above may be implemented as software, firmware, hardware, or an appropriate combination thereof. In hardware implementations, the division of function modules/units mentioned in the above description does not necessarily correspond to the division of physical components. For example, a physical component may have a plurality of functions, or a function or a step may be performed by several physical components operating together. Some or all components may be implemented as software executed by a processor, such as a digital signal processor or a microprocessor. Some or all components may also be implemented as hardware, or as integrated circuits, such as application-specific integrated circuits. Such software may be distributed on a computer-readable medium. The computer-readable medium may include computer storage media (or non-transitory media) and communication media (or transient media). As is well known by those of ordinary skills in the art, the term “computer storage media” includes volatile and non-volatile, removable, and non-removable media implemented by any method or technology for storing information (such as computer-readable instructions, data structures, program modules, or other data). The computer storage media include, but is not limited to, RAM (random access memory), ROM (read only memory), EEPROM (electrically erasable programmable read only memory), flash memory or other memory technologies, CD-ROM (compact disc read-only memory), DVD (digital versatile disc) or other optical disk storage, magnetic cassette, magnetic tape, magnetic disk storage or other magnetic storage apparatus, or any other medium that may be configured to store desired information and may be accessed by a computer. Furthermore, it is well known by those of ordinary skills in the art that, the communication media typically includes computer-readable instruction, data structure, program module, or other data in modulated data signal (the modulated data signal is for example the carrier wave or other transmission mechanisms), and may include any information delivery medium.

The above description is only a preferred embodiment of the disclosed scheme and does not limit the patent scope of the present disclosure. Any equivalent changes to the structure made by the content of the description and drawings of the present disclosure, or direct or indirect usages in other related technical field are, as long as within the idea of the technical scheme of the present disclosure, are included in the patent protection scope of the present disclosure.

What is claimed is:

1. An emission power adjusting method, comprising:
during a scanning cycle, adjusting an emission power according to a first adjusting time interval and based on a configured step size and an adjusting direction, performing a first type of frame data transfer, and obtaining data transmission performance data for the first type of frame data transfer; and
in a case where it is determined that the data transmission performance data meets a condition for ceasing adjustment, ceasing further adjustment of the emission power, and determining an operating emission power.

2. The method as claimed in claim 1, wherein
in a case where the adjusting direction is to decrease, the in a case where it is determined that the data transmission performance data meets the condition for ceasing adjustment, ceasing further adjustment of the emission power comprises:
in a case where the data transmission performance data drops below a first threshold, ceasing the further adjustment of the emission power; or
in a case where the adjusting direction is to increase, the in a case where it is determined that the data transmission performance data meets the condition for ceasing adjustment, ceasing further adjustment of the emission power comprises:
in a case where the data transmission performance data rises above a second threshold, ceasing the further adjustment of the emission power.

3. The method as claimed in claim 1, wherein
the data transmission performance data includes: a data transmission rate, or an expected maximum data transmission throughput.

4. The method as claimed in claim 1, further comprising:
according to the operating emission power determined by a first scanning cycle and the operating emission power determined by a second scanning cycle, determining a third scanning cycle based on the second scanning cycle;
wherein the second scanning cycle is a scanning cycle following the first scanning cycle, the third scanning cycle is a scanning cycle following the second scanning cycle.

5. The method as claimed in claim 4, wherein
in a case where the operating emission power in the second scanning cycle is the same as the operating emission power in the first scanning cycle, determining the third scanning cycle based on the second scanning cycle; wherein the third scanning cycle is greater than the second scanning cycle.

6. The method as claimed in claim 4, wherein
in a case where the operating emission power in the second scanning cycle is different from the operating emission power in the first scanning cycle, determining the third scanning cycle based on the second scanning cycle; wherein the third scanning cycle is less than or equal to the second scanning cycle.

7. The method as claimed in claim 5, wherein
the third scanning cycle is integer multiple of the second scanning cycle.

8. The method as claimed in claim 5, wherein
according to pre-configured levels, determining the third scanning cycle based on the second scanning cycle.

9. The method as claimed in claim 8, wherein
the according to pre-configured levels, determining the third scanning cycle based on the second scanning cycle comprises:
according to the pre-configured levels, based on the level matching the second scanning cycle, selecting the scanning cycle matching a level reduced by one level as the third scanning cycle; wherein in the pre-configured levels, the lower the level, the longer the scanning cycle matching the level; or
according to the pre-configured levels, based on the level matching the second scanning cycle, selecting the scanning cycle matching a level increased by one level as the third scanning cycle; wherein in the pre-configured levels, the higher the level, the longer the scanning cycle matching the level.

10. The method as claimed in claim 4, further comprising:
according to the operating emission power determined by the second scanning cycles of multiple groups and the operating emission power determined by the third scanning cycles of the multiple groups, determining a fourth scanning cycle based on the third scanning cycle of a last group in the multiple groups;
wherein the fourth scanning cycle is a scanning cycle following the third scanning cycle in the last group, the fourth scanning cycle is less than the third scanning cycle in the last group.

11. The method as claimed in claim 10, wherein
the according to the operating emission power determined by the second scanning cycles of the multiple groups and the operating emission power determined by the third scanning cycles of the multiple groups, determining the fourth scanning cycle based on the third scanning cycle of the last group in the multiple groups comprises:
in a case where for the second scanning cycle and the third scanning cycle of each group, the operating emission power determined by the second scanning cycle is different from the operating emission power determined by the third scanning cycle, determining the fourth scanning cycle based on the third scanning cycle in the last group.

12. A communication chip comprising a processor, wherein the processor is configured to execute an emission power adjusting method, the emission power adjusting method comprises:
during a scanning cycle, adjusting an emission power according to a first adjusting time interval and based on a configured step size and an adjusting direction, performing a first type of frame data transfer, and obtaining data transmission performance data for the first type of frame data transfer; and
in a case where it is determined that the data transmission performance data meets a condition for ceasing adjustment, ceasing further adjustment of the emission power, and determining an operating emission power.

13. The communication chip as claimed in claim 12, wherein
in a case where the adjusting direction is to decrease, the in a case where it is determined that the data transmission performance data meets the condition for ceasing adjustment, ceasing further adjustment of the emission power comprises:
in a case where the data transmission performance data drops below a first threshold, ceasing the further adjustment of the emission power; or
in a case where the adjusting direction is to increase, the in a case where it is determined that the data transmission performance data meets the condition for ceasing adjustment, ceasing further adjustment of the emission power comprises:
in a case where the data transmission performance data rises above a second threshold, ceasing the further adjustment of the emission power.

14. The communication chip as claimed in claim 12, wherein
the data transmission performance data includes: a data transmission rate, or an expected maximum data transmission throughput.

15. The communication chip as claimed in claim 12, wherein
the emission power adjusting method further comprises:
according to the operating emission power determined by a first scanning cycle and the operating emission power determined by a second scanning cycle, determining a third scanning cycle based on the second scanning cycle;
wherein the second scanning cycle is a scanning cycle following the first scanning cycle, the third scanning cycle is a scanning cycle following the second scanning cycle.

16. The communication chip as claimed in claim 15, wherein
in a case where the operating emission power in the second scanning cycle is the same as the operating emission power in the first scanning cycle, determining the third scanning cycle based on the second scanning cycle; wherein the third scanning cycle is greater than the second scanning cycle; or
in a case where the operating emission power in the second scanning cycle is different from the operating emission power in the first scanning cycle, determining the third scanning cycle based on the second scanning cycle; wherein the third scanning cycle is less than or equal to the second scanning cycle.

17. An electronic device, comprising:
one or more processors; and
a storage apparatus, configured to store one or more programs;
wherein the one or more programs enable, when being executed by the one or more processors, the one or more processors to implement an emission power adjusting method,
the emission power adjusting method comprises:
during a scanning cycle, adjusting an emission power according to a first adjusting time interval and based on a configured step size and an adjusting direction, performing a first type of frame data transfer, and obtaining data transmission performance data for the first type of frame data transfer; and
in a case where it is determined that the data transmission performance data meets a condition for ceasing adjustment, ceasing further adjustment of the emission power, and determining an operating emission power.

18. The electronic device as claimed in claim 17, wherein
in a case where the adjusting direction is to decrease, the in a case where it is determined that the data transmission performance data meets the condition for ceasing adjustment, ceasing further adjustment of the emission power comprises:
in a case where the data transmission performance data drops below a first threshold, ceasing the further adjustment of the emission power; or
in a case where the adjusting direction is to increase, the in a case where it is determined that the data transmission performance data meets the condition for ceasing adjustment, ceasing further adjustment of the emission power comprises:
in a case where the data transmission performance data rises above a second threshold, ceasing the further adjustment of the emission power.

19. The electronic device as claimed in claim 17, wherein
the emission power adjusting method further comprises:
according to the operating emission power determined by a first scanning cycle and the operating emission power determined by a second scanning cycle, determining a third scanning cycle based on the second scanning cycle;
wherein the second scanning cycle is a scanning cycle following the first scanning cycle, the third scanning cycle is a scanning cycle following the second scanning cycle.

20. The electronic device as claimed in claim 19, wherein
in a case where the operating emission power in the second scanning cycle is the same as the operating emission power in the first scanning cycle, determining the third scanning cycle based on the second scanning cycle; wherein the third scanning cycle is greater than the second scanning cycle; or
in a case where the operating emission power in the second scanning cycle is different from the operating emission power in the first scanning cycle, determining the third scanning cycle based on the second scanning cycle; wherein the third scanning cycle is less than or equal to the second scanning cycle.
